(19) United States
(12) Patent Application Publication
(10) Pub. No.: US 2014/0167316 A1
(43) Pub. Date: Jun. 19, 2014

(54) METHOD AND DEVICE FOR THE PRODUCTION OF FORM PARTS

(71) Applicant: HENNECKE GMBH, SANKT AUGUSTIN (DE)

(72) Inventors: Frank GOEBEL, KOELN (DE); Bernhard WILLING, BONN (DE)

(73) Assignee: HENNECKE GMBH, SANKT AUGUSTIN (DE)

(21) Appl. No.: 14/132,541

(22) Filed: Dec. 18, 2013

(30) Foreign Application Priority Data
Dec. 18, 2012 (DE) 10 2012 024 673.0

(51) Int. Cl. B29C 69/00

(52) U.S. Cl. CPC B29C 69/00
USPC 264/238; 425/317

(57) ABSTRACT

The invention relates to a method for the production of form parts from multi-component reactive plastic material, especially from polyurethane, wherein a plurality of moulds are moved by means of mould carriages (1) at least temporarily along a closed, preferably oval, production line (2). To allow an easy, efficient and quick cleaning of the production line the invention proposes that temporarily instead of at least one mould carriage (1) a cleaning carriage (1b) is arranged in the production line (2), wherein the cleaning carriage (1b) is equipped with rolls (3) and is moved with the same on a stationary ground (4) and wherein the stationary ground (4) is cleaned with the cleaning carriage (1b). Furthermore, the invention relates to a device for the production of form parts.

The invention relates to a method for the production of form parts from multi-component reactive plastic material, especially from polyurethane, wherein a plurality of moulds are moved by means of mould carriages at least temporarily along a closed, preferably oval, production line. Furthermore, the invention relates to a device for the production of form parts.

DE 44 44 280 C2 discloses a method and a device of the generic kind, The device comprises a production line, which production line is designed as an elongated oval. Here a plurality of working station is arranged along the coverage of the oval structure, wherein it can also be a matter of mould carriages. In the document a concept is proposed, which allows the supply of the working stations with signals and with energy respectively, namely the supply of the mould carriages with electrical signals and with different energies (e. g. electrical energy, water for tempering, hydraulic oil, vacuum or compressed air).

Also known are facilities, at which a mould with a mould carriage is arranged as an independent carriage, which carriage is coupled on a rotary chain. If such a carriage shall be exported, the carriage which has to take over the exported mould carriage has to be synchronized first with the facility. Then this mould carriage will be moved or pulled upon the other carriage, wherein then the supply lines will be disconnected by means of quick coupling.

It is disadvantageous with this method that a second carriage has to be synchronized first. Furthermore an essential longer swing is necessary, so that the shifting consumes a relatively long time. A subsequent export of several carriages one by one is thereby considerably more difficult to realize and in general not possible.

WO 1999/010155 describes a mould carriage which is hung up including the supply aggregation on a rail system which runs above the mould carriages. Indeed the hanging arrangement causes a very good accessibility to the mould from both sides but on the other side it is structural very complex, because the mould carriage including the aggregations have to be guided and positioned respectively with log position tolerances, wherein the mould carriage including the aggregations have a high weight in the hanging position at least in that region in which the reactive mixture is often automatically injected by a robot.

At facilities of the mentioned kind the rotating mould carriages have to be supplied at least with electrical signals as well as with energy (particularly with pressure energy, preferably with compressed air, if applicable with hydraulic medium or with electrical energy) to be able to fulfill functionalities such as e. g. the opening and the closing of the mould, the locking of the mould or the operating of automated pressure relief valves. Furthermore, a tempering of the mould is normally required, so that the moulds have to be also supplied with a tempering medium (or to heat if needed also with electrical heating energy).

Furthermore, it is necessary in such facilities, that individual molds or mould carriages can be imported or exported for the purpose of maintenance or for the purpose of variation of the form geometry. Of course it is very advantageous in economical point of views, if this has no or at least a very small impact only on the average cycle time of the components and thus on the productivity of the device.

A third important aspect is the cleaning of the production line. Also here it is advantageous due to economical reasons, if the facility efficiency will be influenced hereof as less as possible. The facility concept and the design of the facility have in fact a not irrelevant impact hereupon. A well maintained clean facility has on a continuing basis a very positive effect on the reliability and productivity of the whole process.

With view on the mentioned criteria the pre-known solutions are not yet optimal, wherein especially the cleaning of the production line is not unproblematic and requires often an interruption of the operation; accordingly, respective negative effects are given in terms of the economy of the process.

Thus it is an object of the invention, to further develop a method and a device of the kind mentioned above in such a way, that an improved possibility of cleaning is created which has no or only a minor influence to the economy of the operation. So, it should be possible to keep the production line clean in a simple manner to guarantee permanently a high quality and an economic operation.

The solution of this object is characterized according to the method in that temporarily instead of at least one mould carriage a cleaning carriage is arranged in the production line, wherein the cleaning carriage is equipped with rolls and is moved with the same on a stationary ground and wherein the stationary ground. is cleaned with the cleaning carriage.

Preferably, a plurality of supply carriages is arranged along the closed production line at a conveying element, which supply carriages are moved by means of the conveying elements, wherein the cleaning carriage is coupled with a supply carriage and is moved by the same. Preferably, for the import into the production line the cleaning carriage is driven up to a not occupied supply carriage and is coupled with the same, wherein the cleaning carriage is thereby moved with its rolls on the stationary ground, wherein the cleaning carriage for moving along the production line in the coupled state with the supply carriage is guided and moved by the supply carriage, wherein the cleaning carriage is moved thereby with its rolls on the stationary ground and wherein for the export from the production line the cleaning carriage is de-coupled from the supply carriage and is driven away from the production line, wherein the cleaning carriage is thereby moved with its rolls on the stationary ground.

Preferably, the cleaning carriage is supplied by the supply carriage with signals and/or energy in the state in which the cleaning carriage is coupled with the supply carriage.

Thereby, the cleaning carriage can clean the stationary ground by means of an aggregation for soakage of dirt. Alternatively or additively it can be provided that for cleaning at least one brush is provided which sweeps the ground. Furthermore, alternatively or additively the cleaning carriage can clean from magnetic waste by means of at least one magnet.

Each mould carriage can preferably be coupled with a supply carriage and can be equipped with rolls so that the mould carriage is driven by a supply carriage and rolls on the stationary ground, wherein the mould carriage is approached to a not occupied supply carriage and is coupled with the same to introduce the mould carriage into the production line, wherein here the mould carriage is moved on the stationary ground with its rolls, wherein for the movement along the production line the mould carriage is guided and moved by the supply carriage in a coupled state between the mould carriage and the supply carriage, wherein here the mould carriage is moved with its rolls on the stationary ground and wherein the mould carriage is decoupled from the supply carriage and is moved away from the production line for taking the mould carriage out of the production line, wherein here the mould carriage is moved with its rolls on the stationary ground. Thus, accordingly the mould carriage systems are functionally divided in a mould carriage and in a supply carriage.

In the case in which the production line is designed as closed, preferably oval, path with straight and arcuated sections the cleaning carriage and/or the mould carriages are preferably exported from the production line at an entry of a straight section into an arcuated section. Correspondingly, it can be provided that in the case of such a design of the production line the cleaning carriage and/or mould carriages are imported into the production line at an entry from an arcuated into a straight section, wherein preferably the cleaning carriage and/or a mould carriage is moved for the import into the production line at first to a free space between two supply carriages at or into the production line, wherein then the supply carriage which follows in conveying direction pushes the cleaning carriage and/or mould carriage onto the supply carriage which is intended for the reception of the cleaning carriage and/or mould carriage, whereby the cleaning carriage and/or the mould carriage is brought synchronically in its coupling position with the supply carriage which receives the cleaning carriage and/or the mould carriage.

The coupling and the decoupling of a cleaning carriage and/or a mould carriages at a and from a supply carriage takes place preferably by a shift movement of the cleaning carriage and/or mould carriage which movement is horizontal and perpendicular to the movement direction of the supply carriage.

A cleaning carriage which is decoupled from a supply carriage and/or a mould carriage which is decoupled from a supply carriage is preferably pushed out of the production line by a supply carriage which follows this supply carriage.

The device for the production of form parts from multi-component reactive plastic material comprises a plurality of moulds arranged on mould carriages and a closed, preferably oval, production line, along which the mould carriages can be moved, wherein the device is characterized according to the invention by at least one cleaning carriage which is equipped with rolls and which can be moved with the rolls on a stationary ground, wherein the cleaning carriage is designed to clean the stationary ground, wherein along the closed production line a plurality of supply carriages is arranged at a conveying element which supply carriages can be moved by the conveying element and wherein the at least one cleaning carriage is designed to be detachable coupled with the supply carriages.

Preferably, displacement means are arranged by which the cleaning carriage can be moved horizontally and perpendicular to the movement direction of the supply carriage to couple or decouple the cleaning carriage to the or from the supply carriage. Thereby, the cleaning carriage and the supply carriage are preferably equipped with coupling means by which the cleaning carriage can be supplied with signals and/or energy from the supply carriage.

Furthermore, the cleaning carriage can comprise at least one guide element which is designed for engagement into a guide bar which is arranged at the stationary ground, to guide the cleaning carriage in the direction of the guide bar.

At the suggested solution thus it is about a method for the production of form parts from multi-component reactive plastic material, especially from polyurethane, wherein the moulds are moved by means of mould carriages along a closed (e. g. oval) production line. A mould carriage which is arranged in the production line is preferably from time to time, thus temporarily, substituted by a cleaning carriage which cleans the ground on which also the mould carriages move on their own (guide) rolls on a stationary ground through the production line. Thus, according to the invention a mould carriage is exported from the production line and a cleaning carriage is imported instead, which also moves on own guided rolls along the stationary ground. Thus, after the export of a mould carriage from the production line the cleaning carriage, which is arranged on its own guide rolls, is imported into the production line to carry out the cleaning of the facility.

Preferably, the cleaning carriage is equipped with an aggregation for soakage of dirt, with brushes for sweeping of contaminations and/or with several magnets for collecting of metal parts.

The cleaning of the production line becomes possible, by the method and the device according to the invention in specifically economical manner.

At the supply carriages it is mostly about carriages, which carriages are permanently coupled on a rotary chain (conveyor element) and on which carriages aggregates are installed for the provision of electrical energy, temper water, pressure energy and/or vacuum.

At the mould carriages it is about carriages on which the mould carriages elements and the molds are arranged. These carriages possess own (guide) rolls which move on the stationary ground. This is usually the hall ground or a road which is fixed on the hall ground.

The functional separation of the mould carriage, which has to be imported and exported for the maintenance and for the change of the mould, from the supply carriage, on which supply carriage the aggregates are arranged for the provision of pressure energy (e. g. compressed air) as well as for the tempering, causes, that no more aggregates have to be installed (e. g. temper devices and compressed air reservoirs) than there are places for the mould carriages in the production lire. This has relevant economical advantages.

Through that it will be also possible, that for example a temper device or a compressed air reservoir can serve several forms, because these aggregates won't be exported and therefore are independent of thereof, which mould carriages will be exported or imported concretely in that moment, always stay in the production line and are available.

Furthermore the arrangement of the mould carriages with own guide rolls, on which guide rolls the mould carriage moves also within the production line across the hall ground, makes a large convenience and flexibility possible at the importing and exporting and at the following handling of the mould carriages. Advantageously a further transport medium won't be necessary, on which medium the mould carriage will be moved further after the decoupling and whose movement also would have to be synchronized with the conveying facility.

Accordingly a simple and very advantageous importing and exporting of the cleaning carriage and of the mould carriages into the production line is ensured.

As already mentioned above the cleaning carriage and the mould carriages will be exported preferably at the entry into the areas of the bends of the production line (in case of an oval design), by decoupling them from the support carnage first by a slight respectively marginal translational horizontal shifting perpendicular to the conveying direction. Afterwards the decoupled carriage will be then moved out of the production line without own drive from the following still coupled supply carriage (if applicable along a guide). The further transport occurs in the simplest case then by manual pushing, it can occur also automatically of course, for example by friction wheels.

The export of the cleaning carriage and the mould carriage in the bend (i. e. in a bent section of the production line) offers thereby several essential advantages compared to an export in a straight area. The carriage has to be only transferred slightly parallel for the decoupling from the supply carriage (translational perpendicular to the conveying direction) and can then continue right away for the export out of the production line. During an export in the area of the straight, an essential bigger parallel displacement is necessary (at least by one whole width of a carriage).

For the further transport of the cleaning carriage and mould carriage respectively after the export, no additional driven carriage is required; in the easiest case the cleaning carriage and mould carriage respectively can be moved to its maintenance station and keeping station respectively by hand. Often, a high automation in the area of maintenance is not reasonable economically, so that the simplicity and the high flexibility of this method are very advantageous. Of course the cleaning carriage and mould carriage respectively can be transported further also in an automatic way. A simple possibility are e. g. driven stationary friction wheels, which actuate the cleaning carriage and mould carriage respectively.

The further described embodiments allow the use of further advantages of the invention. Hereafter the cleaning carriage and the mould carriages respectively will be imported from the transition of the bent area into the straight area of the oval (or if applicable for example also in form of a rounded rectangle) production line, at first by moving them again to a free space between two supply carriages, wherein then they will be transported further and positioned from the following support carriage, before they will be then coupled again to the supply carriage by translational shifting perpendicular to the conveying direction (parallel shifting).

Accordingly, a simple cleaning of the track of the facility is ensured. At the production of form parts, mostly vehicle seat cushion made from polyurethane soft foam, planed waste occurs at each mould. Thereby it is a matter of foam rests which accrue at the venting point of the moulds. Likewise insert parts such as wires or texture frazzles can get onto the track. If such contaminations won't be removed on a regular basis, the function of the facility is strongly jeopardized. With the suggested method an easy import of a cleaning carriage into the production line is possible as well as a very simple cleaning of the ground, on which the mould carriages move. Because the whole carriage can be exchanged very easily, the design of the cleaning carriage can be optimized concerning the cleaning function. So that the import and export function well analog to the import and export of the mould carriages, only the dimensions of the cleaning carriage have to correspond with respect to the stops of the supply carriages with those of the mould carriages. The cleaning carriage can then be connected at least electrically to a supply carriage and will be supplied by it with electrical energy.

Also, the cleaning carriage and mould carriage respectively needs not to be led continuous between the import and export point along the given lanes. In many cases a manual pushing of the cleaning carriage and mould carriages respectively within the maintenance area is more reasonable in terms of economy which is not obligated to given stationary lanes due to the high flexibility and due to the low investment costs. Because the cleaning carriage and mould carriage respectively is equipped with guide rolls this simple and uncomplicated handling of the cleaning carriage and mould carriages respectively in the maintenance area is realizable without any problems.

Accordingly the invention provides an economical method to keep the (oval)conveying device clean. In this connection the aspects of the economy are particularly the investment cost, the cycle times and the utilization of the facility respectively, especially in consideration of the maintenance and cleaning respectively of the facility. So, a cleaning carriage can be imported into the production line in periodic intervals almost without lost of cycle time and thus an optimized maintenance of the facility can be ensured. A dirty facility leads normally on a long-term view always to an increased machine downtime and consequently to a worse economy of the facility.

A functional separation will be provided on the one hand of the circling transportation carriages concerning the energy respectively the signal support and on the other hand of the mould carrier and cleaning unit respectively, that is to say a separation into a supply carriage and into a cleaning carriage and mould carriage respectively. The cleaning carriage and mould carriage respectively is designed as an autarkic unit (with guide rolls), which doesn't have to be taken over from another transport carriage after the decoupling from the supply carriage. Through that, advantageously, a synchronization of the transport carriage with the facility is not necessary, which synchronization otherwise would have been necessary. Through this also a large amount of mould carriages can get exchanged directly one after the other without any waste of time and the cleaning carriage can be imported and exported quickly without problems.

In the drawings an embodiment of the invention is depicted. It shows:

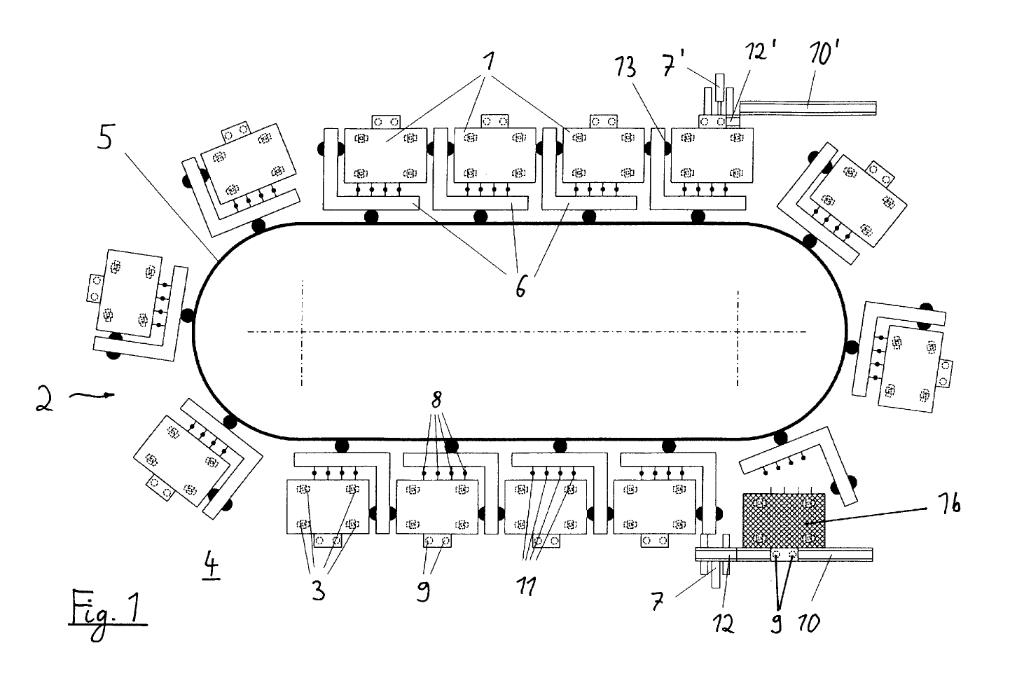

FIG. 1 in a top plan view a production hue with an oval. conveying element with a plurality of supply carriages, a cleaning carriage and mould carriages and

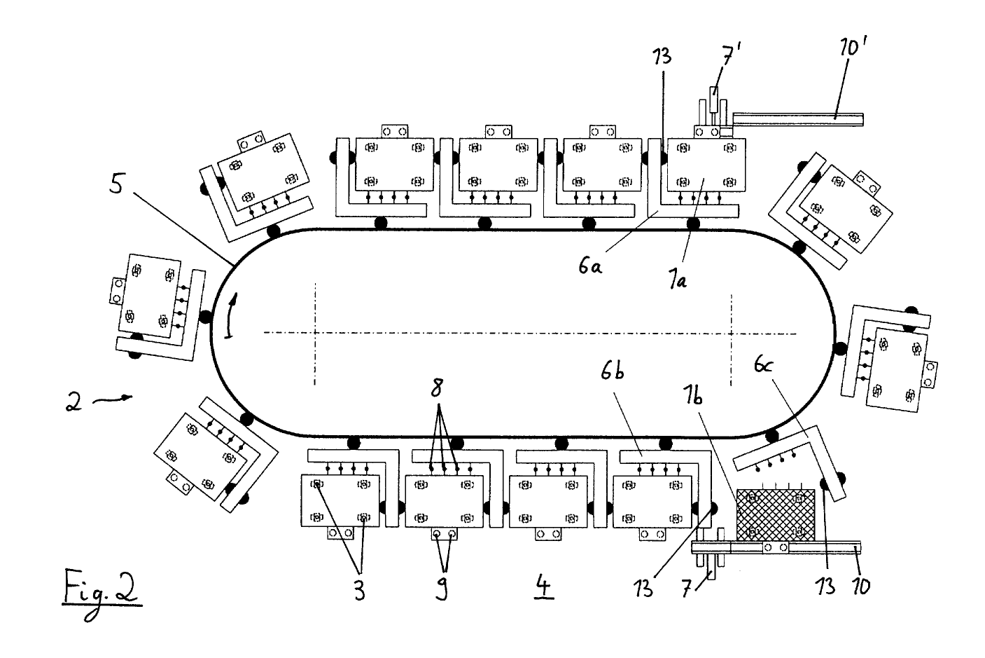

FIG. 2 to

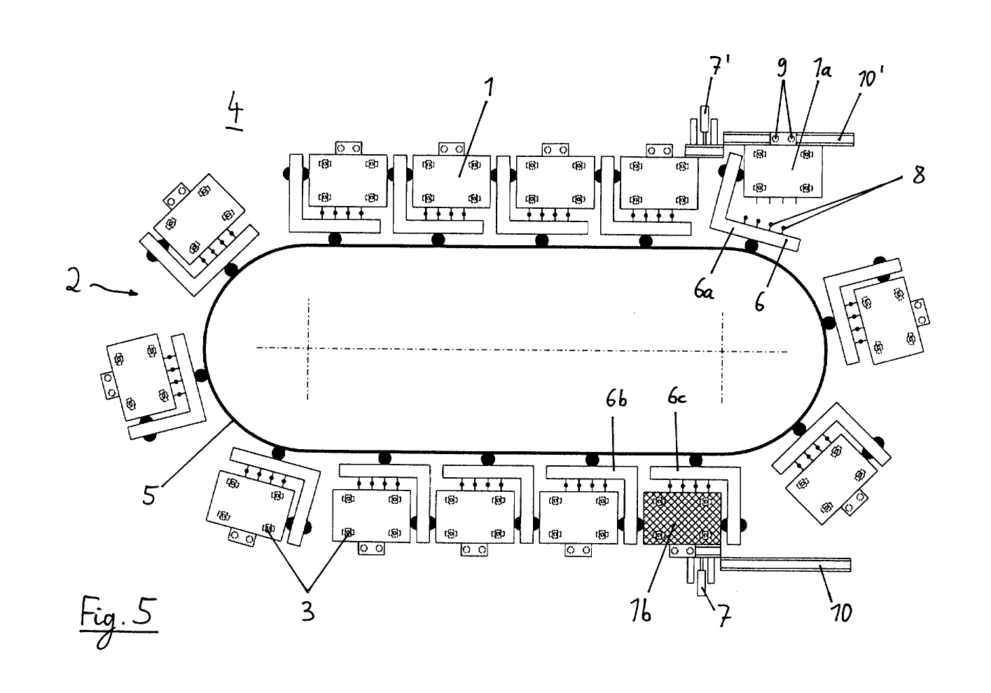

FIG. 5 stepwise the import and export of a cleaning carriage and of a mould carriage in the production line.

In FIG. 1 a production line 2 is depicted schematically. It comprises a conveying element 5 (rotating chain), which conveying element is designed presently as oval conveyor. Supply carriages 6 are fixed on the rotating chain 5. The supply carriages 6 are designed to couple detachably on each of them a mould carriage 1; on the mould carriages 1 there is a mould for the production of a form part. Furthermore, a cleaning carriage 1b is provided.

The support lines of the support carriages 6 are connected via coupling means 8 in form of quick coupling with the corresponding lines 11 of the mould carriage 1 and of the cleaning carriage 1b respectively.

The halves of the mould can be lifted or lowered and be swung respectively depending on the application. The opening and closing of the moulds occurs preferably across stationary bases (not depicted), which are passed by the mould carriage 1. Then the bases move a stop at the mould which stop is connected with a set of levers. Then, by this set of levers each mould half can be moved/swung around a swivel bearing. At this kind of opening and closing of the moulds, i. e. via stationary bases, the bases should possibly not be arranged near the ground level, thus below the mould carriages but laterally and/or above the same. So it is guaranteed that the ground can be cleaned by the cleaning carriage 1b in an easy manner as it is described hereinafter.

The mould carriages 1 as well as the cleaning carriage 1b roll on four articulated rolls 3 across the stationary ground 4. Outside the mould carriage and also outside the cleaning carriage 1b two guide rolls 9 are fixed. By these guide rolls 9 the cleaning respectively mould carriage 1, 1b can be moved parallel, i. e, horizontal and perpendicular to the conveying direction, across a stationary traversing slide 12, 12′ by means of a stationary displacement means 7, 7′ (stationary cylinder) or also by means of another stationary device at the import and export respectively of a cleaning respectively mould carriage 1, 1b, Furthermore the guide rolls 9 arrange, that the cleaning respectively mould. carriage 1, 1b will be moved further after the export from the support carriage 6 by means of a stop 13 in a guide bar 10′. Analog a guide bar 10 serves the guided lead of a cleaning respectively mould carriage 1, 1b during the import. Likewise analog to the export the cleaning respectively mould. carriage 1, 1b can be shifted parallel during the import across the traversing slide 12 by means of the stationary displacement means 7 across the guide rolls 9.

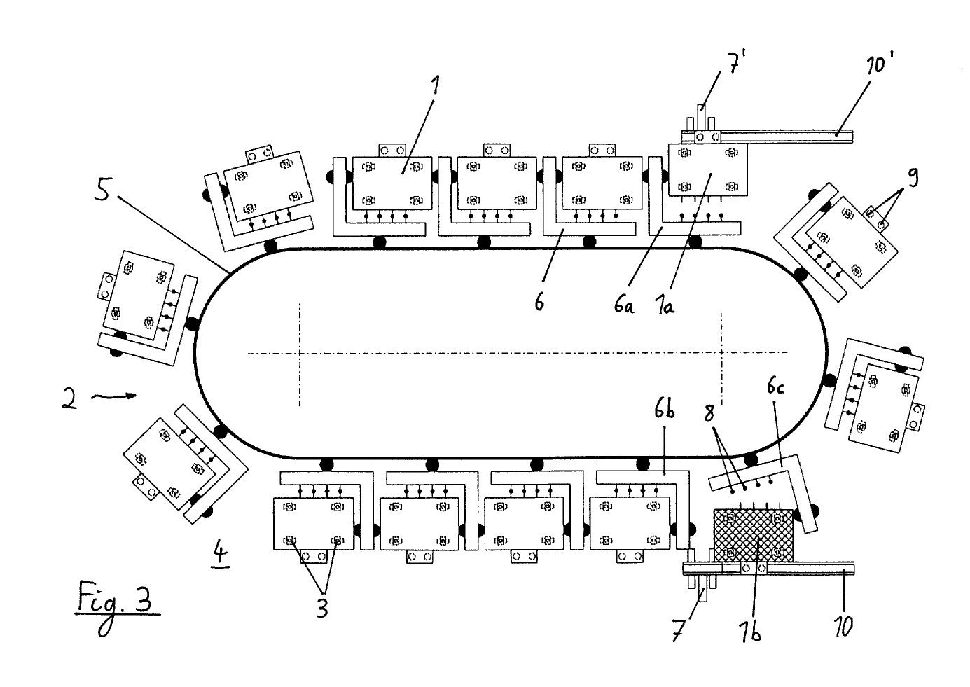

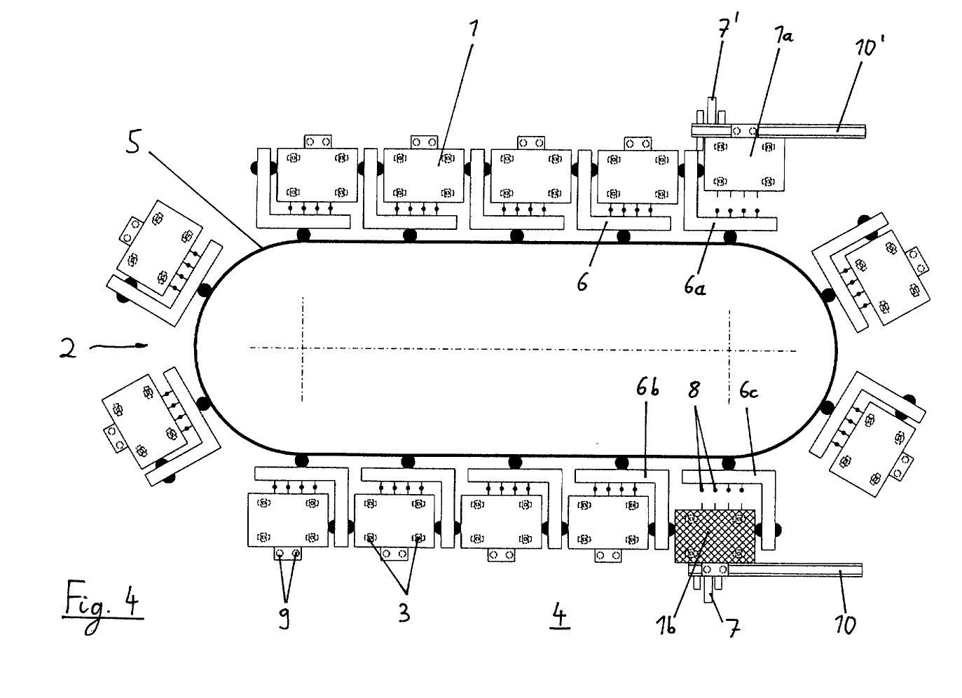

In the FIGS. 2 to 5 the export of a mould carriage 1 as well as the import of a cleaning carriage 1b from respectively into the production line 2 is depicted here step by step for the preferred embodiment.

During the export the mould carriage 1a will be shifted parallel at the entry into the bend area of the oval convoying element 5 first across the stationary traversing slide 12′ by means of the stationary displacement means 7′, i. e. translational into the direction perpendicular to the conveying direction. The decoupled mould carriage 1a will be pushed further from the supply carriage 6a across the stop 13. The guide bar 10′, which is fixed on the ground, arranges that the carriage 1a will be led straight ahead. For the further handling the carriage 1a can be moved further by hand or can be taken over from another conveying line.

During the import of a cleaning carriage 1b into the oval conveyor the cleaning carriage 1b which has to be imported will be pushed first across the guide bar 10 between the preparatory support carriage 6b and the support carriage 6c, which has to take over the cleaning carriage 1b. It will be positioned in the correct position at the run-out of the bend between the stop 13 of the preparatory supply carriage 6b and the stop 13 of the support carriage 6c, which has to take over the cleaning carriage 1b. Across the stationary traversing slide 12. the cleaning carriage 1b which has to be imported. will be shifted parallel by means of the stationary displacement means 7; in doing so the support lines will be connected with another by the quick coupling means 8.

When the cleaning carriage 1b is imported it is pulled by its supply carriage 6 while it is cleaning the ground with respective cleaning elements and cleaning aggregations respectively.

The export of the cleaning carriages 1b occurs analogue to the export of the mould carriage 1a.

### LIST OF REFERENCES

1 Mould carriage
1a Mould carriage
1b Cleaning carriage
2 Production line
3 Roll (guide roll)
4 Stationary ground 5 Conveying element (rotating chain)
6 Supply carriage
6a Supply carriage
6b Supply carriage
6c Supply carriage
7 Displacement means
7′ Displacement means
8 Coupling means (quick coupling)
9 Guide element (guiding roll)
10 Guide bar
10′ Guide bar
11 Line
12 Stationary traversing slide
12′ Stationary traversing slide
13 Stop

1. Method for the production of form parts from multi-component reactive plastic material, comprising:
moving a plurality of moulds by means of mould carriages at least temporarily along a closed production line.
wherein
temporarily instead of at least one mould carriage a cleaning carriage is arranged in the production line, wherein the cleaning carriage is equipped with rolls and is moved with the same on a stationary ground and wherein the stationary ground is cleaned with the cleaning carriage.

2. Method according to claim 1, wherein a plurality of supply carriages is arranged along the closed production line at a conveying element, which supply carriages are moved by means of the conveying elements, wherein the cleaning carriage is coupled with a supply carriage and is moved by the same.

3. Method according to claim 2, wherein for the import into the production line the cleaning carriage is driven up to a not occupied supply carriage and is coupled with the same, wherein the cleaning carriage is thereby moved with its rolls f on the stationary ground, wherein the cleaning carriage for moving along the production line in the coupled state with the supply carriage is guided and moved by the supply carriage, wherein the cleaning carriage is moved thereby with its rolls on the stationary ground and wherein for the export from the production line the cleaning carriage is de-coupled from the supply carriage and is driven away from the production line, wherein the cleaning carriage is thereby moved with its rolls on the stationary ground.

4. Method according to claim 2, wherein the cleaning carriage is supplied by the supply carriage with signals and/or energy in the state in which the cleaning carriage is coupled with the supply carriage.

5. Method according to claim 1, wherein the cleaning carriage cleans the stationary ground by means of an aggregation for soakage of dirt and/or sweeps by means of at least one brush and/or cleans by means of at least one magnet from magnetic waste.

6. Method according to claim 1, wherein each mould carriage can be coupled with a supply carriage and is equipped with rolls so that the mould carriage is driven by a supply carriage and raps on the stationary ground, wherein the mould carriage is approached to a not occupied supply carriage and is coupled with the same to introduce the mould carriage into the production line, wherein here the mould carriage is moved on the stationary ground with its rolls, wherein for the movement along the production line the mould carriage is guided and moved by the supply carriage in a coupled state between the mould carriage and the supply carriage, wherein here the mould carriage is moved with its rolls on the stationary ground and wherein the mould carriage is decoupled from the supply carriage and is moved away from the production line for taking the mould carriage out of the production line, wherein here the mould carriage is moved with its rolls on the stationary ground.

7. Method according to claim 1, wherein in the case in which the production line is designed as closed path with straight and arcuated sections the cleaning carriage and/or the mould carriages are exported from the production line at an entry of a straight section into an arcuated section.

8. Method according to claim 1, wherein in the case in which the production line is designed as closed path with straight and arcuated sections the cleaning carriage and/or mould carriages are imported into the production line at an entry from an arcuated into a straight section, wherein preferably the cleaning carriage and/or a mould carriage is moved for the import into the production line at first to a free space between two supply carriages at or into the production line, wherein then the supply carriage which follows in conveying direction pushes the cleaning carriage and/or mould carriage onto the supply carriage which is intended for the reception of the cleaning carriage and/or mould carriage, whereby the cleaning carriage and/or the mould carriage is brought synchronically in its coupling position with the supply carriage which receives the cleaning carriage and/or the mould carriage.

9. Method according to claim 1, wherein the coupling and the decoupling of a cleaning carriage and/or a mould carriages at a and from a supply carriage takes place by a shift movement of the cleaning carriage and/or mould carriage which movement is horizontal and perpendicular to the movement direction of the supply carriage.

10. Method according to claim 1, wherein a cleaning carriage which is decoupled from a supply carriage and/or a mould carriage which is decoupled from a supply carriage is pushed out of the production line by a supply carriage which follows this supply carriage.

11. Device for the production of form parts from multi-component reactive plastic material, comprising a plurality of moulds arranged on mould carriages and a dosed production line, along which the mould carriages can be moved, especially for carrying out the method according to claim 1,
wherein
at least one cleaning carriage which is equipped with rolls and which can be moved with the rolls on a stationary ground, wherein the cleaning carriage is designed to clean the stationary ground,
wherein along the closed production line a plurality of supply carriages is arranged at a conveying element which supply carriages can be moved by the conveying element and
wherein the at least one cleaning carriage is designed to be detachable coupled with the supply carriages.

12. Device according to claim 10, wherein displacement means are arranged by which the cleaning carriage can be moved horizontally and perpendicular to the movement direction of the supply carriage to couple or decouple the cleaning carriage to the or from the supply carriage, wherein preferably the cleaning carriage and the supply carriage are equipped with coupling means by which the cleaning carriage can be supplied with signals and/or energy from the supply carriage.

13. Device according to claim 11, wherein the cleaning carriage comprise at least one guide element which is designed for engagement into a guide bar which is arranged at the stationary ground, to guide the cleaning carriage in the direction of the guide bar.
